(19) United States
(12) Patent Application Publication
(10) Pub. No.: US 2015/0071149 A1
(43) Pub. Date: Mar. 12, 2015

(54) Power Saving in a Multiple Sector Radio Base Station

(71) Applicants: Ulf Skärby, Lidingo (SE); Thomas Östman, Spanga (SE); Karin Skarman, Stockholm (SE)

(72) Inventors: Ulf Skärby, Lidingo (SE); Thomas Östman, Spanga (SE); Karin Skarman, Stockholm (SE)

(73) Assignee: Telefonaktiebolaget L M Ericsson (publ), STOCKHOLM (SE)

(21) Appl. No.: 14/394,243

(22) PCT Filed: Apr. 25, 2012
(86) PCT No.: PCT/SE2012/050431

§ 371 Date: Oct. 13, 2014

(51) Int. Cl. H04W 52/02; H04B 7/04

(52) U.S. Cl. CPC H04W 52/0206; H04B 7/0495
USPC 370/311

(57) ABSTRACT

A multiple sector RBS and a method therein for controlling the RBS is provided. The RBS is connectable to multiple sector antenna units supporting N sectors, N≧2, being associated with respective cell ids. The RBS comprises N Radio Units, RUs, serving the sectors. The method comprises transmitting (110) a respective cell id in each individual sector; deciding (115) that at least two individual sectors shall be merged; deciding (120) which at least two sectors that shall be merged; and identifying their respective cell id. The method comprises determining (125) one cell id out of the identified at least two cell ids to be active, wherein the remaining cell id(s) to be passive; and transitioning (130), in each sector associated with a passive cell id, from transmitting the passive cell id to transmitting the active cell id. The method comprises switching off (135) RU(s) responsible for transmitting the passive cell ids.

### TECHNICAL FIELD

The present disclosure relates to a multiple sector RBS and in particular to controlling of the multiple sector RBS.

### BACKGROUND

A radio access network of a wireless or cellular communication network comprises a plurality of radio base stations, RBSs, distributed over an area. The area may be a region, a city, a country or several countries. Generally, each RBS is associated with a coverage area which is commonly referred to as a cell in case of so called omni RBSs. In case of multiple sector RBSs, the coverage area of the multiple sector RBS can be divided into a number of sectors. A sector can have several carriers, wherein each carrier can be called a cell. Each cell is typically associated with a cell id. An individual cell id is transmitted in each cell by the RBS or multiple sector RBS.

In a wireless or cellular communication network, users having user equipments may move around causing the traffic load in each cell or RBS to vary over time. In case of multiple sector RBSs, a user may also move about within the different sectors or even cells of the multiple sector RBS. As a result, some RBSs may experience very heavy traffic loads at certain times, these times are also referred to as peak hours.

Typically, the radio access network of a wireless or cellular communication network is designed such that it will be able to cope with the highest amount of traffic during peak hours. In order for the radio access network to be able to cope with the highest amount of traffic during peak hours, the RBSs of the radio access network are typically individually designed to have resources or capacity powerful enough to be able to cope with the highest amount of traffic during peak hours.

However, peak hours occur at different RBSs at different times during the day and/or night. The peak hours may last a relatively short time of the 24 hours of a day and night. For example, for an RBS having a coverage area encompassing a plurality of office buildings in a city, the peak hours of the day may be during office hours. For an RBS having a coverage area encompassing e.g. a shopping mall, the peak hours may be during lunch time and in the afternoon. Regardless of when an RBS experiences peak hours of high traffic load, an RBS also experiences hours of “average” traffic load and hours of relatively “low” traffic load. During such hours, the RBS will have resources or capacity that are wasted or unused, requiring excessive power usage.

In order to reduce power consumption during off-peak hours, i.e. hours that are not peak hours, some parts or components may be switched off. One problem is to switch off those parts or components without dropping current connections between user equipments, UEs, and the RBS.

### SUMMARY

The object is to obviate at least some of the problems outlined above. In particular, it is an object to provide a multiple sector RBS and a method therein for controlling the RBS, wherein the multiple sector RBS merges at least two of its sectors while retaining connections between UEs and the multiple sector RBS. These objects and others may be obtained by providing a multiple sector RBS and a method in a multiple sector RBS according to the independent claims attached below.

According to an aspect a method in a multiple sector RBS for controlling the multiple sector RBS is provided. The multiple sector RBS is connectable to multiple sector antenna units supporting N sectors, where N≧2, the sectors being associated with respective cell identities, ids. The multiple sector RBS comprises N Radio Units, RUs, serving the sectors. The method comprises transmitting, by means of an RU, in each individual sector, a respective cell id associated with the individual sector. The method further comprises deciding that at least two individual sectors shall be merged, and deciding which at least two sectors out of the N sectors that shall be merged and further identifying the respective cell id of the at least two sectors. Further, the method comprises determining one cell id out of the identified at least two cell ids that shall be active, wherein the remaining cell id(s) out of the identified cell ids shall be passive; and transitioning, in each sector associated with a cell id that shall be passive, from transmitting the cell id that shall be passive to transmitting the cell id that shall be active. The method also comprises switching off RU(s) responsible for transmitting the cell ids which has become passive when a transmission power for transmitting those cell id(s) has reached a threshold power value.

According to an aspect, a multiple sector RBS for controlling the multiple sector RBS is provided. The multiple sector RBS is connectable to multiple sector antenna units supporting N sectors, where N≧2. The sectors are associated with respective cell ids and the multiple sector RBS comprises N RUs serving the sectors. The multiple sector RBS comprises a processing unit adapted to transmit by means of an RU, in each individual sector, the respective cell id associated with the sector and a carrier. The processing unit is also adapted to decide that at least two separate sectors shall be merged, and to decide which at least two sectors out of the N sectors that shall be merged. Further, the processing unit is adapted to identify the respective cell id of the at least two sectors, and to determine one cell id out of the identified cell ids that shall be active, wherein the remaining cell id(s) out of the identified cell ids shall be passive. The processing unit is also adapted to transition, in each sector associated with a cell id that shall be passive, from transmitting the cell id that shall be passive to transmitting the one determined cell id that shall be active; and to switch off RU(s) responsible for transmitting the cell ids which has become passive when a transmission power for transmitting those cell id(s) has reached a threshold power value.

The multiple sector RBS and the method therein have several advantages. By transitioning, in each sector associated with a cell id that shall be passive, from transmitting the cell id that shall be passive to transmitting the cell id that shall be active, any UE being located in a sector in which a cell id that shall be passive is transmitted will be handed over to the cell id that shall be active. Thereby, the connections between the UEs and the multiple sector RBS are retained while the RBS applies power saving functions by switching off RU(s).

### BRIEF DESCRIPTION OF DRAWINGS

Embodiments will now be described in more detail in relation to the accompanying drawings, in which:

FIGS. 1a and 1b are a flowchart of a method in a multiple sector RBS for controlling the multiple sector RBS according to an exemplifying embodiment.

FIG. 2a is a block diagram of a multiple sector RBS for controlling the multiple sector RBS according to an exemplifying embodiment.

FIG. 2b is a block diagram of a multiple sector RBS for controlling the multiple sector RBS according to an exemplifying embodiment.

FIGS. 3a-3e are an example of a multiple sector RBS having three sectors and merging them all into one sector.

### DETAILED DESCRIPTION

Briefly described, a multiple sector RBS and a method therein for controlling the RBS are provided. The method enables the RBS to save power by merging at least two of its sectors such that the merged sectors can be supported by just one Radio Unit, RU, and the extra RU(s) may be switched off, wherein the connections between the UEs and the multiple sector RBS are retained.

A multiple sector RBS obviously has a plurality of sectors. The RBS has a coverage area, which is also referred to as a cell, or even cells, in which the RBS is able to provide services to UEs being located within the coverage area. For simplicity, assume the RBS has one cell constituting its coverage area. A multiple sector RBS can then be said to divide the cell into a plurality of sectors. In order to support a plurality of sectors, the multiple sector RBS is equipped with, or connected to, a plurality of antenna units.

The multiple sector RBS transmits different cell identities, cell ids, in individual sectors. This means that a UE being located within a first sector of the multiple sector RBS “sees” a first RBS transmitting a first cell id, and a UE being located within a second sector of the multiple sector RBS “sees” a second RBS transmitting a second cell id.

The cell ids are used by the UEs to measure e.g. signal strength from the serving RBS or the serving “sector” of the multiple sector RBS as well as signal strength from neighbouring RBS or neighbouring sectors. In the case of a multiple sector RBS, a UE moving from a first sector to a second sector will initially receive the cell id of the first sector with higher signal strength than that of the cell id of the second sector. As the UE keeps moving towards the second sector, the signal strength of the received cell id of the first sector will decrease and the signal strength of the received cell id of the second sector will increase. At some point in time, they will be equal and at some point in time, the cell id of the second sector is received with higher signal strength than the cell id of the first sector. This will eventually result in the UE being handed over from the first sector to the second sector.

The multiple sector RBS comprises individual RUs, one RU for each antenna unit. The number of sectors, the number of RUs and the number of antenna units are the same. For example, in case the multiple sector RBS has five sectors, the multiple sector RBS also has five antenna units and five RUs.

The RUs are connectable to the antenna units and in the example of the multiple sector RBS having five sectors, wherein all the five sectors are in use, each individual RU is connected to a respective individual antenna unit. It is the RUs that are responsible for transmitting the different cell ids in the individual sectors.

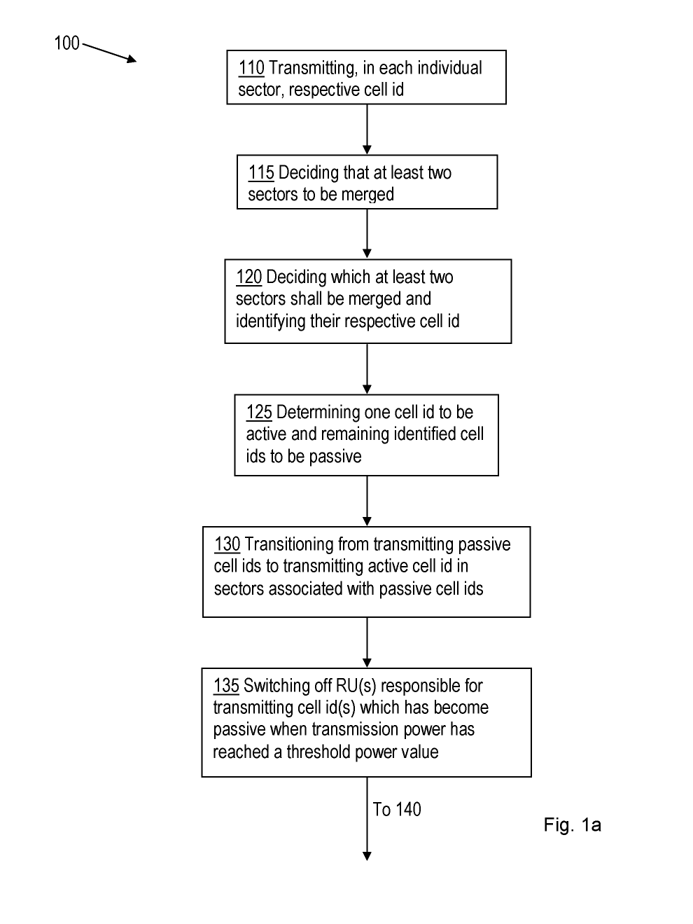

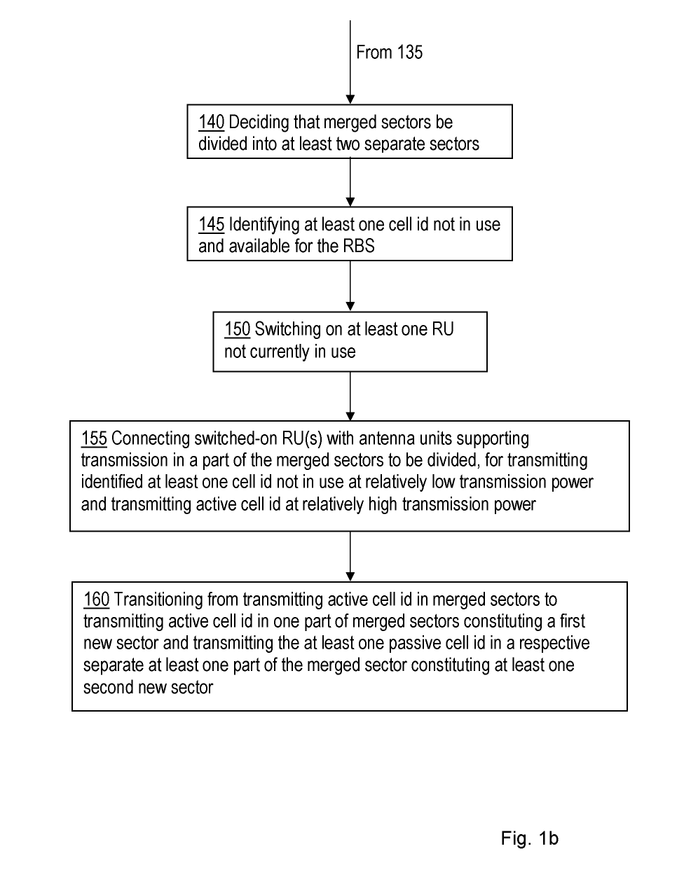

An exemplifying embodiment of a method in a multiple sector RBS for controlling the multiple sector RBS will now be described with reference to FIGS. 1a and 1b.

The multiple sector RBS is connectable to multiple sector antenna units supporting N sectors, where N≧2, the sectors being associated with respective cell ids. The RBS comprises N RUs serving the sectors.

FIG. 1a illustrates the method comprising transmitting 110, by means of an RU, in each individual sector, a respective cell id associated with the individual sector. The method further comprises deciding 115 that at least two individual sectors shall be merged, and deciding 120 which at least two sectors out of the N sectors that shall be merged and further identifying the respective cell id of the at least two sectors. Further, the method comprises determining 125 one cell id out of the identified at least two cell ids that shall be active, wherein the remaining cell id(s) out of the identified cell ids shall be passive; and transitioning 130, in each sector associated with a cell id that shall be passive, from transmitting the cell id that shall be passive to transmitting the cell id that shall be active. The method also comprises switching off 135 RU(s) responsible for transmitting the cell ids which has become passive when a transmission power for transmitting those cell id(s) has reached a threshold power value.

To begin with, the multiple sector RBS is transmitting a respective cell id in each of the individual sectors by means of the RU. Merely as an example, assume the multiple sector RBS has three RUs, connected to three antenna units, thereby supporting, or having, three sectors. A first RU is connected to a first antenna unit and transmits a first cell id in a first sector, a second RU is connected to a second antenna unit and transmits a second cell id in a second sector; and a third RU is connected to a third antenna unit and transmits a third cell id in a third sector.

At one point in time, the multiple sector RBS decides that at least two individual sectors shall be merged, and decides which at least two sectors out of the N sectors that shall be merged. Assume for simplicity that two sectors shall be merged so that they together constitute one sector. Since two sectors are to be merged, the multiple sector RBS is currently transmitting two individual cell ids in the two sectors that shall be merged, one cell id in each sector. Once the sectors are merged, only one cell id is needed since the merged sectors will constitute one single sector. The method in the multiple sector RBS comprises identifying the respective cell id of the at least two sectors. Further, the method comprises determining one cell id out of the identified at least two cell ids that shall be active, wherein the remaining cell id(s) out of the identified cell ids shall be passive. In other words, the multiple sector RBS selects one out of the two cell ids that the multiple sector RBS will continue to use in the whole “new” sector, i.e. the sector constituting the merged two sectors. This cell id that the multiple sector RBS will continue to use once the sectors have been merged is also referred to as the active cell id, or the cell id that shall be active. As a consequence, the other cell id in this example will not be used once the sectors have been merged and the other cell id is referred to as the cell id that shall be passive, or the passive cell id. Once the merger of the sectors is complete, the passive cell id may still be available for the multiple sector RBS even if it is not currently in use.

Once the multiple sector RBS has decided which sectors are to be merged, which cell id that shall be in use after the merger, i.e. the cell id that shall be active, and which cell id that shall not be in use after the merger, i.e. the cell id that shall be passive, the RBS transitions in each sector associated with a cell id that shall be passive, from transmitting the cell id that shall be passive to transmitting the cell id that shall be active. This results in that the cell id that shall be active, or the active cell id, will be transmitted in the one single sector constituting the merged sectors and that the cell id that shall be passive will not be transmitted any longer.

The multiple sector RBS also switches off 135 RU(s) responsible for transmitting the cell ids which has become passive when a transmission power for transmitting those cell id(s) has reached a threshold power value. This means that when the passive cell id(s) are being transmitted with a transmission power equal to, or below, the threshold power value, the multiple sector RBS also switches off RU(s) responsible for transmitting the passive cell id(s).

The threshold power value is in one example equal to zero. In another example, the threshold power value equals 5% of the maximum transmission power with which a cell id may be transmitted.

The method has several advantages. By transitioning, in each sector associated with a cell id that shall be passive, from transmitting the cell id that shall be passive to transmitting the cell id that shall be active, any UE being located in a sector in which a cell id that shall be passive is transmitted will be handed over to the cell id that shall be active. Thereby, the connections between the UEs and the multiple sector RBS are retained while the RBS applies power saving functions by switching off RU(s).

In an example, the transitioning 130 comprises adding, at a predetermined transmission power, the determined one cell id in those sectors associated with cell ids that shall be passive and successively increasing the transmission power of the determined one cell id, and successively reducing the transmission power with which the cell id(s) which shall be passive are transmitted in each respective sector.

In other words, by adding the determined one cell id in those sectors associated with cell ids that shall be passive, the RBS transmits in those sectors the respective cell id(s) that shall be passive at normal transmission power and concurrently transmits the cell id that shall be active at a predetermined transmission power. The predetermined transmission power is in one example relatively low, e.g. <5% of the maximum transmission power with which the cell id may be transmitted, but it is in another the predetermined transmission power corresponds to normal transmission power. This means that at the very beginning of the transitioning, the cell id(s) that shall be passive are transmitted at normal transmission power and at the same time the cell id that shall be active is transmitted at a predetermined transmission power, in those sectors being associated with a cell id that shall be, or become, passive. In the sector associated with the cell id that shall be active, only the cell id that shall be active is transmitted at normal transmission power.

Thereafter, the transmission power with which the cell id that is active is transmitted in those sectors being associated with a cell id that shall be, or become, passive is successively increased. Simultaneously, the transmission power with which the cell id(s) which shall be passive are transmitted in each respective sector is successively reduced. Alternatively, the transmission power with which the cell id that shall be active is transmitted in those sectors being associated with a cell id that shall be, or become, passive is successively increased until it has reached a normal transmission power level and thereafter, the transmission power with which the cell id(s) which shall be passive are transmitted in each respective sector is successively reduced. It shall be pointed out that the increase of transmission power of the cell id that shall be active and the decrease of transmission power of the cell id that shall become passive may be performed independently of each other.

For the UEs being located in the sector(s) being initially associated with cell id(s) that shall become passive, the transitioning is experienced as if the UEs are “travelling” towards the sector initially associated with cell id(s) that shall be active. This is because the signal strength with which the cell id(s) that shall become passive is received will decrease and the signal strength with which the cell id that shall be active is received will increase. This will trigger handover of the UE(s) from the cell id(s) that shall become passive to the cell id that shall be active.

In still an example, the transitioning 130 further comprises connecting the RU originally responsible for transmitting the one determined active cell id in a respective sector with antenna units supporting all the merged sectors.

Before the merger of the at least two sectors, each RU is connected to a respective antenna unit. The individual RUs are responsible for transmitting the individual cell ids in the respective sectors. When the multiple sector RBS starts transmitting, at the predetermined transmission power, the cell id that shall be active in those sectors being associated with a cell id that shall become passive, it is the RUs responsible for those sectors that transmits both the cell id that shall become passive and the cell id that shall be active.

Once the RUs responsible for the sectors that shall be merged all transmit the active cell id at normal transmission power, and no RU is transmitting the cell id(s) that shall be passive at a transmission power exceeding the threshold power value, the multiple sector RBS connects the RU originally responsible for transmitting the one determined active cell id in a respective sector with antenna units supporting all the merged sectors.

When the RU originally responsible for transmitting the one determined active cell id in a respective sector is connected with antenna units supporting all the merged sectors, the RU(s) originally responsible for transmitting the cell id(s) that has become passive are disconnected from antenna units supporting all the merged sectors.

The result is that the RU originally responsible for transmitting the one determined active cell id in a respective sector will now be responsible for transmitting the active cell id in all of the one single sector constituting the merged sectors. The disconnected RU(s) originally responsible for transmitting the cell id(s) that has become passive may then be switched off.

In yet an example, deciding 115 that at least two individual sectors shall be merged comprises receiving, from a controller of the radio network, a message with instruction(s) to merge the at least two individual sectors.

In this example, an operator, or a higher layer node makes the decision to merge the at least two sectors and instructs the multiple sector RBS to perform the merger by sending a message with instruction(s) to merge the at least two individual sectors. The higher layer node may be a network controller of the radio access network or an operation and maintenance node in a core network.

In still an example, deciding 115 that at least two individual sectors shall be merged comprises determining, in the multiple sector RBS, that a current load of the multiple sector RBS is below a predefined load threshold.

The multiple sector RBS monitors its current load situation in this example. As described above, the load may vary quite substantially during the hours of the day and night. The predefined threshold indicates to the multiple sector RBS that the traffic load is such that at least two sectors may be merged so that at least one RU may be switched off in order to reduce power consumption of the multiple sector RBS.

In yet an example, deciding 115 that at least two individual sectors shall be merged comprises detecting that a predefined time of day has been reached.

As described above, peak hours of heavy traffic may occur at different times during the night and day. Depending on where the RBS is located, what types of buildings/facilities are located within its coverage area, e.g. offices, shopping malls and residential houses, the peak hours may occur at different times for different RBSs. The occurrence of peak hours are relatively easy to statistically predict so that the decision to merge at least two sectors may be based on what time of day it currently is.

Merely as an example, for a multiple sector RBS encompassing mainly offices, the traffic load may be relatively low before 6 a.m. and increase to medium between 8 a.m. and 10 a.m. and then peak at 11 a.m. before lunch. Then during lunch between e.g. 11.30 a.m. and 12.30 p.m. the traffic load drops to relatively low. Then the traffic load increases again at 1 p.m. peaking at e.g. 3 p.m. and then being relatively low from 6 p.m. until 6 a.m. In this example, the multiple sector RBS may decide to merge at least two individual sectors at e.g. 11.30 a.m. and at 6 p.m. This implies that the multiple sector RBS must also subsequently split up previously merged sectors in order to cope with an increase of traffic load, which will be described in detail below.

According to an embodiment, illustrated in FIG. 1b, the method further comprises deciding 140 that the merged sectors shall be divided into at least two separate sectors; and identifying 145 at least one cell id available for the RBS which is passive and not in use. The method comprises switching on 150 at least one RU not currently in use, and connecting 155 the switched-on RU(s) with antenna units supporting transmission in a part of the merged sectors that shall be divided, for transmitting the identified at least one cell id which is passive at the predetermined transmission power and transmitting the active cell id at relatively high transmission power. The method also comprises transitioning 160, in the merged sectors to be divided from transmitting the active cell id in the merged sectors to transmitting the active cell id in one part of the merged sectors constituting a first new sector; and transmitting the at least one passive cell id in a respective separate at least one part of the merged sectors constituting at least one second new sector.

This assumes that at least two sectors have previously be merged as described above. At some point in time, the multiple sector RBS decides that the merged sectors shall be divided into at least two separate sectors. When the decision is made, the multiple sector RBS is transmitting one single cell id in the merged sectors. In order to divide the merged sectors into at least two separate sectors, at least one additional cell id is needed. The additional cell id will be sent in the at least one new sector that will come out of the merged sectors when they are divided.

The multiple sector RBS identifies at least one cell id available for the RBS which is passive and not in use. In case the merged sectors are to be divided into two sectors, a first sector and a second sector, then one additional cell id is needed. The current cell id which is transmitted in all of the merged sectors will, after the division, only be sent in one part of the merged sectors constituting the first sector. The one additional cell id will after the division be sent in the second sector. In case the merged sectors are to be divided into three sectors, a first sector, a second sector and a third sector, then two additional cell ids are needed.

Then the multiple sector RBS switches on at least one RU not currently in use, and connects the switched-on RU(s) with antenna units supporting transmission in a part of the merged sectors that shall be divided, for transmitting the identified at least one cell id which is passive at the predetermined transmission power and transmitting the active cell id at relatively high transmission power. Assume for simplicity that the merged sector shall be divided into two sectors, the first sector and the second sector as exemplified above. Then one additional cell id is identified and one RU currently not in use is switched on. After the RU is switched on, the multiple sector RBS connects the RU with an antenna unit supporting transmission in the part of the merged sector constituting the second sector after the division is complete. The switched on RU starts transmitting the active cell id at relatively high transmission power. By “relatively high” means a transmission power necessary for the cell id to be used in a sector, e.g. at least 50% of a maximum transmission power with which the cell id can be sent. Relatively high transmission power can also be seen as normal transmission power. The switched on RU also starts transmitting the identified cell id which is currently passive and not in use at a predetermined transmission power which may be relatively low, e.g. <5% of the maximum transmission power with which the cell id may be transmitted. Once the switch-on RU is transmitting both cell ids, at different transmission powers, the RU is connected to the antenna unit supporting transmission in the part of the merged sector constituting the second sector after the division is complete.

Before the switched-on RU is connected, there is only one RU, referred to as the original RU, which is connected to all antenna units supporting transmission in all of the merged sector that is to be divided. This original RU is transmitting one cell id, which corresponds to the active cell id referring to when the sectors were being merged as described above. Once the switched-on RU is connected to the antenna unit supporting transmission in the part of the merged sector constituting the second sector after the division is complete, the original RU is disconnected from the same antenna unit but remains connected to the antenna unit supporting transmission in the part of the merged sector constituting the first sector after the division is complete. This means that when the switched-on RU is connected to its antenna unit, the active cell id is transmitted at relatively high transmission power in the second sector together with the passive cell id which is transmitted at the predetermined transmission power by means of the switched-on RU. For the first sector, the original RU transmits the active cell id at relatively high transmission power.

Thereafter, the multiple sector RBS transitions in the merged sectors to be divided from transmitting the active cell id in the merged sectors to transmitting the active cell id in one part of the merged sectors constituting the first new sector and transmitting the at least one passive cell id in a respective separate at least one part of the merged sectors constituting at least one second new sector. It shall be noted that the at least one passive cell id is no longer a passive cell id after the transitioning is complete.

Once the transitioning is compete, the first sector and the at least second sector of the divided merged sectors constitute individual sectors in which individual cell ids are transmitted.

The decision to divide the merged sectors may comprise receiving, from a controller of the radio network, a message with instruction(s) to divide the merged sectors; determining, in the multiple sector RBS, that a current load of the multiple sector RBS is above a predefined load threshold; or that a predefined time of day has been reached.

In an example, the cell ids are scrambling codes and the multiple sector RBS is employed in a Wideband Code Divisional Multiple Access, WCDMA, based radio communication system.

In another example, the multiple sector RBS is employed in a CDMA based communication system, a Global System for Mobile Communication, GSM or a Long Term Evolution, LTE, based system.

The multiple sector RBS may be employed, or used, in different radio communication systems based on different technologies. Depending on the technology used, the cell ids are referred to as e.g. scrambling codes in WCDMA, cell identity codes in LTE and so on.

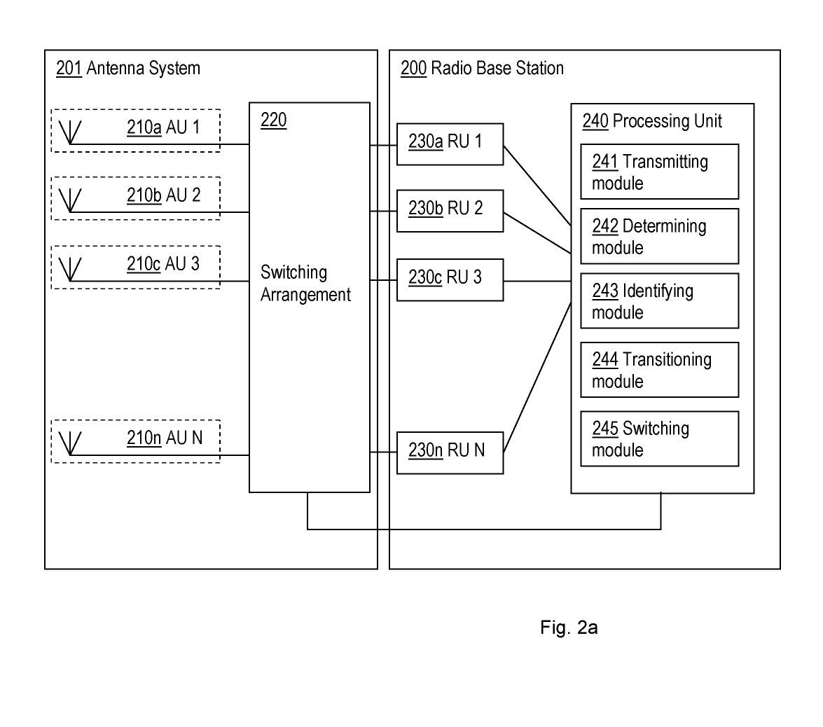

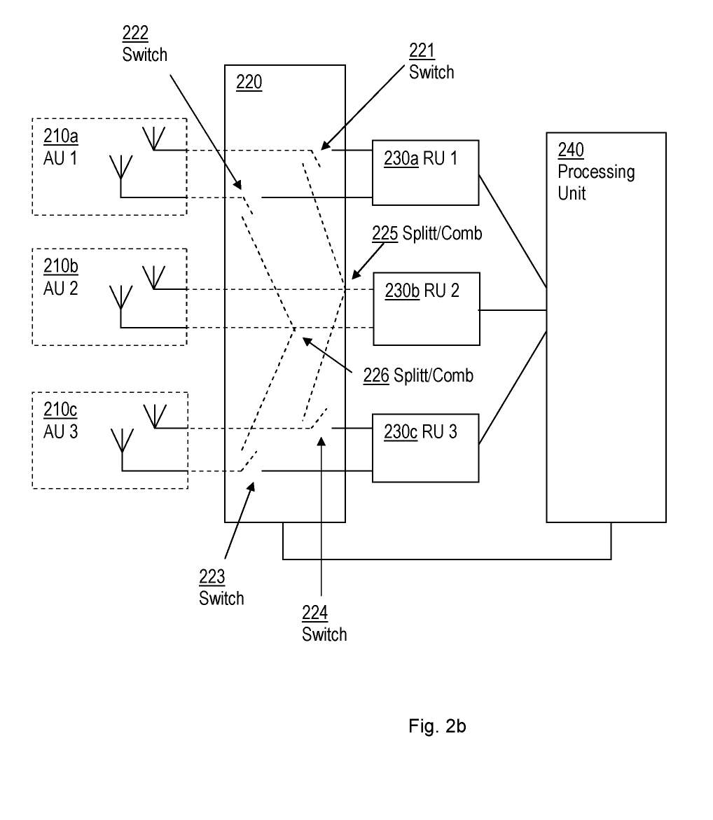

Embodiments herein also relate to a multiple sector RBS for controlling the RBS. An exemplifying embodiment of such a multiple sector RBS will now be described with reference to FIG. 2a. FIG. 2a is a block diagram of an multiple sector RBS for controlling the multiple sector RBS according to an exemplifying embodiment.

The multiple sector RBS has the same technical features, objects and advantages as the method performed therein. The multiple sector RBS will be described in brief in order to avoid unnecessary repetition.

The RBS is connectable to multiple sector antenna units 210a, . . . , 210n supporting N sectors, where N≧2 and the sectors are associated with respective cell identities, ids. The RBS 200 comprises N 230a, . . . , 230n serving the sectors.

FIG. 2a illustrates the RBS comprising a processing unit 240 adapted to transmit by means of an RU 230a, . . . , 230n, in each individual sector, the respective cell id associated with the sector and a carrier. The processing unit 240 is also adapted to decide that at least two separate sectors shall be merged, and to decide which at least two sectors out of the N sectors that shall be merged. Further, the processing unit 240 is adapted to identify the respective cell id of the at least two sectors, and to determine one cell id out of the identified cell ids that shall be active, wherein the remaining cell id(s) out of the identified cell ids shall be passive. The processing unit 240 is also adapted to transition, in each sector associated with a cell id that shall be passive, from transmitting the cell id that shall be passive to transmitting the one determined cell id that shall be active; and to switch off RU(s) responsible for transmitting the cell ids which has become passive when a transmission power for transmitting those cell id(s) has reached a threshold power value.

FIG. 2a illustrates the processing unit 240 of the multiple sector RBS comprising different modules, transmitting module 241, determining module 242, identifying module 243 and transitioning module 244. It shall be noted that FIG. 2a is merely an exemplifying illustration of a multiple sector RBS being configured such that the multiple sector RBS may be controlled according to the method described above. The processing unit 240 of the multiple sector RBS may comprise, other modules and/or units enabling the processing unit to perform the method for controlling the multi sector RBS as described above. FIG. 2a further illustrates the RBS 200 being connected to an Antenna System 201. The Antenna system comprises a Switching Arrangement 220 and antenna units AU1-AUN 210a-210n. It shall be noted that in an alternative solution, the switching arrangement 220 is comprised in the RBS 200 (not shown).

The multiple sector RBS has the same advantages as the method performed therein for controlling the multiple sector RBS. By transitioning, in each sector associated with a cell id that shall be passive, from transmitting the cell id that shall be passive to transmitting the cell id that shall be active, any UE being located in a sector in which a cell id that shall be passive is transmitted will be handed over to the cell id that shall be active. Thereby, the connections between the UEs and the multiple sector RBS are retained while the RBS applies power saving functions by switching off RU(s).

In an example, the processing unit is adapted to add, at a predetermined transmission power, the determined one cell id in those sectors associated with cell ids that shall be passive and to successively increase the transmission power of the determined one cell id, and to successively reduce the transmission power with which the cell id(s) which shall be passive are transmitted in each respective sector.

Looking at FIG. 2a, assume that sector 2 and sector 3 are to be merged with sector 1. Then, RU1 denoted 230a will continue as before by transmitting cell id 1 to antenna unit AU1 denoted 210a. RU2 denoted 230b will transmit, or output, cell id 2 at normal or current transmission power and also add cell id 1 which is transmitted at the predetermined transmission power, preferably but not compulsory being relatively low, e.g. <5% of a maximum transmission power. RU2 230b is connected to antenna unit AU2 denoted 210b and will transmit, or output, cell id 1 and cell id 2 to the antenna unit AU2 210b to be transmitted in sector 2. In FIG. 2a, the different antenna units are also denoted AU1-AUN.

RU3 denoted 230c will transmit, or output, cell id 3 at normal or current transmission power and also add cell id 1 which is transmitted at the predetermined transmission power, preferably but not compulsory being relatively low, e.g. <5% of a maximum transmission power. RU3 230c is connected to antenna unit AU3 denoted 210c and will transmit, or output, cell id 1 and cell id 3 to the antenna unit AU3 210c to be transmitted in sector 3. Then the transitioning takes place such that when the transitioning is complete, RU1, RU2 and RU3 230a-c will all transmit cell id 1 so that sector 1, sector 2 and sector 3 look identical to any UE being located therein and hence, the three sectors are merged into one single sector.

In still an example, the processing unit 240 further is adapted to connect the RU originally responsible for transmitting the one determined active cell id in a respective sector with antenna units supporting all the merged sectors.

FIG. 2a illustrates the multiple sector RBS 200 being connected to a switching arrangement 220 in the Antenna System 201, which is controlled by the processing unit 240. Alternatively, the switching arrangement 220 may be incorporated into the RBS 200. The processing unit 240 is adapted to connect the RU originally responsible for transmitting the one determined active cell id in a respective sector with antenna units supporting all the merged sectors by controlling the switching arrangement 220 to perform this connection. Going back to the case where sector 2 and sector 3 are to be merged with sector 1, this means that once all three RUs 230a-c all transmit cell id 1 in sector 1, sector 2 and sector 3, the switching arrangement 220 connects RU1 230a to antenna units AU2 and AU3 denoted 210b and 210c while it retains the connection of RU1 230a with antenna unit AU1 210a. The result is that RU1 230a becomes connected to all the antenna units AU1-AU3 210a-c supporting all the merged sectors, the merged sectors in this case being sector 1, sector 2 and sector 3.

Connecting RU1 230a to antenna units AU2 and AU3 denoted 210b and 210c also means that RU2 230b becomes disconnected from antenna unit AU2 denoted 210b and RU3 230c becomes disconnected from antenna unit AU3 denoted 210c. Thereafter, RU2 230b and RU3 230c are switched off in order to reduce power consumption.

In still an example, the processing unit 240 is adapted to determine that at least two individual sectors shall be merged by receiving, from a controller of the radio network, an message with instruction(s) to merge the at least two individual sectors.

In another example, the processing unit is adapted to determine that at least two individual sectors shall be merged by determining, in the RBS, that a current load of the RBS is below a predefined load threshold.

In still another example, the processing unit is adapted to determine that at least two individual sectors shall be merged by detecting that a predefined time of day has been reached.

In an example, the processing unit further is adapted to decide that the merged sectors shall be divided into at least two separate sectors; and to identify at least one cell id available for the RBS which is passive and not in use. The processing unit further is adapted to switch on at least one RU not currently in use and to connect the switched-on RU(s) with antenna units supporting transmission in a part of the merged sectors that shall be divided, for transmitting the identified at least one cell id which is passive at the predetermined transmission power and transmitting the active cell id at relatively high transmission power. The processing unit is also adapted to transition, in the merged sectors to be divided from transmitting the active cell id in the merged sectors to transmitting the active cell id in one part of the merged sectors constituting a first new sector and transmitting the at least one passive cell id in a respective separate at least one part of the merged sectors constituting at least one second new sector.

Again looking at FIG. 2a, assume that sector 1, sector 2 and sector 3 has previously been merged as described above and the multiple sector RBS decides that the merged sectors shall be divided into the three original sectors. The multiple sector RBS needs two additional cell ids to be used in order to be able to split the merged sectors and identifies cell id 2 and cell id 3 which are passive and currently not in use after the previous merger of sectors 1-3. There needs to be one RU per sector and cell id and in this case, two additional RUs are required. The multiple sector RBS switches on RU2 230b and RU3 230c and they are controlled by the processing unit 240 to start transmitting cell id 1 at normal transmission power and RU2 230b also starts transmitting cell id 2 at a predetermined transmission power, preferably but not compulsory being relatively low, e.g. <5% of a maximum transmission power. RU3 230c also starts transmitting cell id 3 at a predetermined transmission power, preferably but not compulsory being relatively low, e.g. <5% of a maximum transmission power.

Thereafter, the processing unit 240 connects the switched-on RU(s) with antenna units supporting transmission in a part of the merged sectors that shall be divided, for transmitting the identified at least one cell id which is passive at the predetermined transmission power and transmitting the active cell id at relatively high transmission power. In other words, the processing unit 240 controls the switching arrangement 220 so that the switching arrangement 220 connects RU2 230b to antenna unit AU2 denoted 210b and RU3 230c to antenna unit AU3 denoted 210c. In this manner, cell id 1 is transmitted at normal, or relatively high transmission power in all three sectors and in addition, cell is 2 is transmitted at the predetermined transmission power in sector 2 and cell is 3 is transmitted at the predetermined transmission power in sector 3.

Then the processing unit 240 is adapted to perform the transitioning from transmitting cell id 1 in sector 2 to transmit cell id 2 in sector 2 and from transmitting cell id 1 in sector 3 to transmit cell id 3 in sector 3. This is done by the processing unit controlling the RUs instructing each of them which cell id(s) that shall be transmitted and with what transmission power. In this manner, the previously merged sectors are now divided into three individual sectors.

During the transitioning, any UE being located within sector 2 will “hear” cell id 1 successively worse and cell id 2 successively better wherein the UE(s) eventually will go through handover from cell id 1 to cell id 2. Of course likewise for sector 3 which will transition from cell id 1 to cell id 3. The UEs will retain their connections to the multiple sector RBS and they will experience it has having moved from one cell to another, or one sector to another.

In an example, the cell ids are scrambling codes and the RBS is employed in a WCDMA based radio communication system.

In another example, the multiple sector RBS is employed in a CDMA based communication system, a GSM or an LTE based system.

FIG. 2b is a block diagram of a multiple sector RBS for controlling the multiple sector RBS according to an exemplifying embodiment. FIG. 2b illustrates an example wherein the RBS comprises 3 individual RUs and thus is able to support up to 3 individual sectors. FIG. 2b illustrates an example of the switching arrangement 220 being configured such that the multiple sector RBS is enabled to either transmit one individual cell id in each of the 3 sectors or to transmit cell id 2 in all 3 sectors. The switching arrangement 220 comprises four switches 221-224, each configured to connect or disconnect an antenna connection to/from a respective RU 230a and 230c. The switching arrangement 220 further comprises 2 individual combiners or splitters 225 and 226 configured to connect/disconnect RU2 230b to/from AU1 210a and AU3 210c. The switching arrangement 220 is further configured to always connect RU2 230b to AU2 210b.

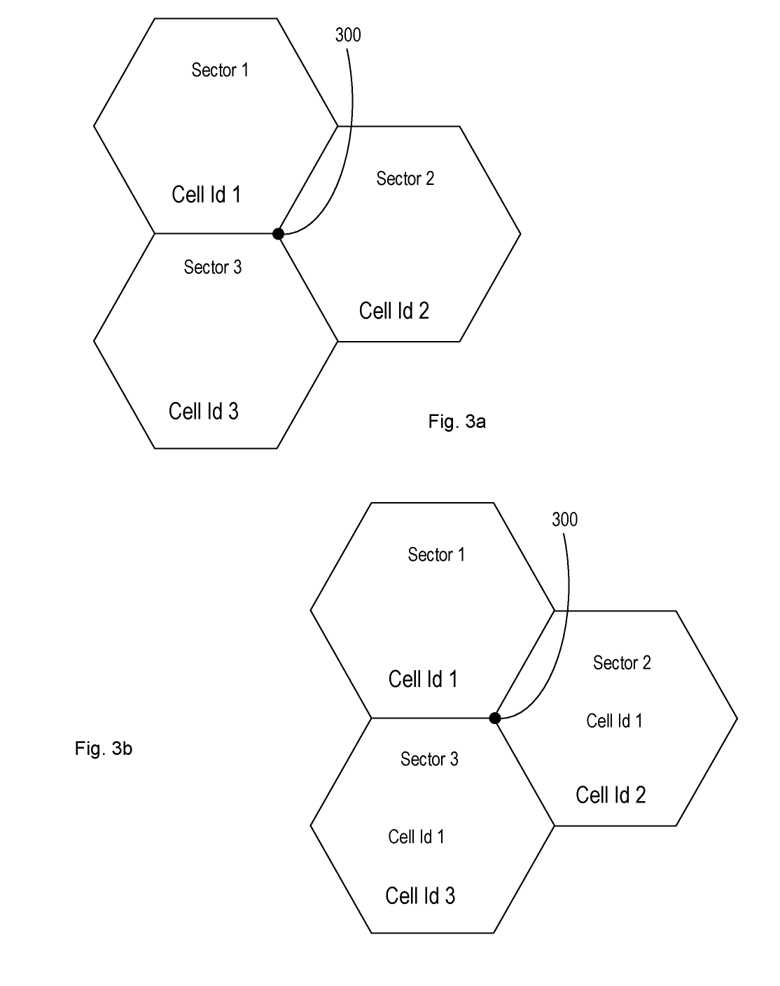

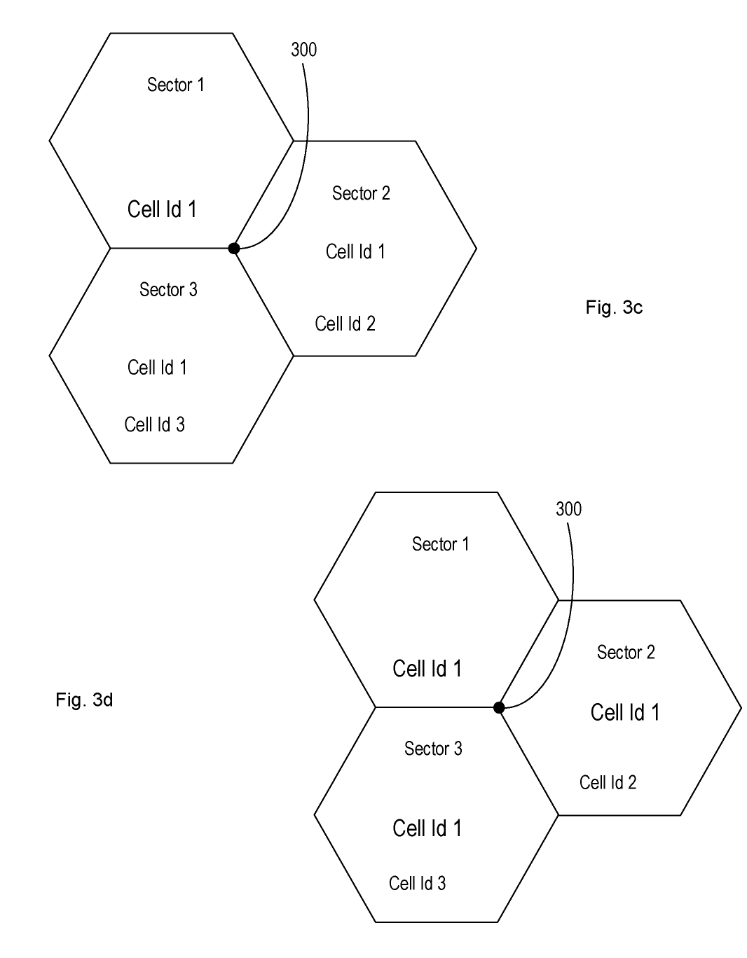

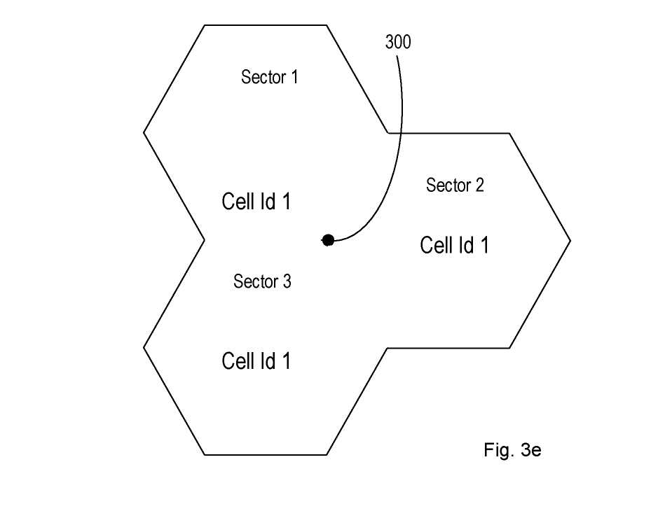

FIGS. 3a-3e illustrate an example of a multiple sector RBS having three sectors and merging them all into one sector. The different FIGS. 3a-3c represent different point in time over which the merging is performed.

FIG. 3a illustrates a multiple sector RBS 300 having three different sectors. In each sector, an individual cell id is transmitted. The cell ids are written in large letters to illustrate that the respective cell id is transmitted at normal, or relatively high, transmission power.

At some point in time, the multiple sector RBS decides to merge the three sectors into one, making the multiple sector RBS become a so-called omni RBS, or omni site. The term site comprises the multiple sector RBS and the antenna system. The multiple sector RBS decides to keep cell id 1 and to make cell id 2 and cell id 3 passive. The multiple sector RBS starts transmitting cell id 1 in both sector 2 and sector 3, but at a relatively low transmission power compared to the transmission power with which cell id 2 and cell id 3 are being transmitted in respective sectors. This is illustrated in FIG. 3b by cell id 2 written in large letters in sector 2 while cell id 1 is written in small letters in sector 2. Likewise for sector 3.

FIGS. 3c and 3d illustrate the transitioning, wherein the cell ids that shall become passive, i.e. cell id 2 and cell id 3, are written in successively smaller letters to illustrate the decrease in transmission power with which these are being transmitted. Cell id 1 is being illustrated in sector 2 and sector 3 as being transmitted by successively higher transmission power by the size of the letters with which cell is 1 is written in sector 2 and sector 3 increasing.

At some point in time, illustrated in FIG. 3e, cell id 2 and cell id 3 are not being transmitted anymore and the transition is complete. Sectors 1 to 3 are now merged as only one cell id is transmitted in all three sectors.

It should be noted that FIG. 2a merely illustrates various functional units and modules in the multiple sector RBS in a logical sense. The functions in practice may be implemented using any suitable software and hardware means/circuits etc. Thus, the embodiments are generally not limited to the shown structures of the multiple sector RBS and the functional units and modules. Hence, the previously described exemplary embodiments may be realised in many ways. For example, one embodiment includes a computer-readable medium having instructions stored thereon that are executable by the processing unit 240 for executing the method steps in the multiple sector RBS. The instructions executable by the computing system and stored on the computer-readable medium perform the method steps of the present invention as set forth in the claims.

FIG. 2a schematically shows an embodiment of a multiple sector RBS 200. Comprised in the multiple sector RBS 200 are here a processing unit 240, e.g. with a DSP (Digital Signal Processor). The processing unit 240 may be a single unit or a plurality of units to perform different actions of procedures described herein. The multiple sector RBS 200 may also comprise an input unit for receiving signals from other entities, and an output unit for providing signal(s) to other entities. The input unit and the output unit may be arranged as an integrated entity or as one or more interfaces.

Furthermore, the multiple sector RBS 200 comprises at least one computer program product in the form of a non-volatile memory, e.g. an EEPROM (Electrically Erasable Programmable Read-Only Memory), a flash memory and a hard drive. The computer program product comprises a computer program, which comprises code means, which when executed in the processing unit 240 in the multiple sector RBS 200 causes the multiple sector RBS 200 to perform the actions e.g. of the procedure described earlier in conjunction with FIGS. 1a and 1b.

The computer program may be configured as a computer program code structured in computer program modules. Hence, in an exemplifying embodiment, the code means in the computer program of the multiple sector RBS 200 comprises a transmitting module for transmitting, by means of a RU, in each individual sector, a respective cell id associated with the individual sector. The computer program further comprises a determining module for deciding that at least two individual sectors shall be merged, and deciding which at least two sectors out of the N sectors that shall be merged and further identifying the respective cell id of the at least two sectors. The determining module also determines one cell id out of the identified at least two cell ids that shall be active, wherein the remaining cell id(s) out of the identified cell ids shall be passive. The computer program further comprises a transitioning module for transitioning, in each sector associated with a cell id that shall be passive, from transmitting the cell id that shall be passive to transmitting the cell id that shall be active. Still further, the computer program comprises a switching module for switching off RU(s) responsible for transmitting the cell ids which has become passive when a transmission power for transmitting those cell id(s) has reached a threshold power value.

The computer program modules could essentially perform the actions of the flow illustrated in FIGS. 1a and 1b, to emulate the multiple sector RBS 200. In other words, when the different computer program modules are executed in the processing unit 240, they may correspond to the modules 241-245 of FIG. 2a.

Although the code means in the embodiment disclosed above in conjunction with FIG. 2a are implemented as computer program modules which when executed in the processing unit causes the multiple sector RBS 200 to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the multiple sector RBS 200.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method in a multiple sector Radio Base Station, RBS, for controlling the RBS, the RBS being connectable to multiple sector antenna units supporting N sectors, where N≧2, the sectors being associated with respective cell identities, ids, the RBS comprising N Radio Units, RUs, serving said sectors, the method comprising:
transmitting, by means of a RU, in each individual sector, a respective cell id associated with the individual sector,
deciding that at least two individual sectors shall be merged, and deciding which at least two sectors out of the N sectors that shall be merged and further identifying the respective cell id of the at least two sectors;
determining one cell id out of the identified at least two cell ids that shall be active, wherein the remaining cell id(s) out of the identified cell ids shall be passive,
transitioning, in each sector associated with a cell id that shall be passive, from transmitting the cell id that shall be passive to transmitting the cell id that shall be active, and
switching off RU(s) responsible for transmitting the cell ids which has become passive when a transmission power for transmitting those cell id(s) has reached a threshold power value.

2. A method according to claim 1, wherein the transitioning comprises adding, at a predetermined transmission power, the determined one cell id in those sectors associated with cell ids that shall be passive and successively increasing the transmission power of the determined one cell id, and successively reducing the transmission power with which the cell id(s) which shall be passive are transmitted in each respective sector.

3. A method according to claim 1, wherein the transitioning further comprises connecting the RU originally responsible for transmitting the one determined active cell id in a respective sector with antenna units supporting all the merged sectors.

4. A method according to claim 1, wherein the deciding that at least two individual sectors shall be merged comprises receiving, from a controller of the radio network, a message with instruction(s) to merge the at least two individual sectors.

5. A method according to claim 1, wherein the deciding that at least two individual sectors shall be merged comprises determining, in the RBS, that a current load of the RBS is below a predefined load threshold.

6. A method according to claim 1, wherein the deciding that at least two individual sectors shall be merged comprises detecting that a predefined time of day has been reached.

7. A method according to claim 1 further comprising:
deciding that the merged sectors shall be divided into at least two separate sectors,
identifying at least one cell id available for the RBS which is passive and not in use,
switching on at least one RU not currently in use,
connecting the switched-on RU(s) with antenna units supporting transmission in a part of the merged sectors that shall be divided, for transmitting the identified at least one cell id which is passive at the predetermined transmission power and transmitting the active cell id at relatively high transmission power, and
transitioning, in the merged sectors to be divided from transmitting the active cell id in the merged sectors to transmitting the active cell id in one part of the merged sectors constituting a first new sector and transmitting the at least one passive cell id in a respective separate at least one part of the merged sectors constituting at least one second new sector.

8. A method according to claim 1, wherein the cell ids are scrambling codes and the RBS is employed in a Wideband Code Divisional Multiple Access, WCDMA, based radio communication system.

9. A method according to claim 1, wherein the RBS is employed in a CDMA based communication system, a Global System for Mobile Communication, GSM or a Long Term Evolution, LTE, based system.

10. A multiple sector Radio Base Station, RBS, for controlling the RBS, the RBS being connectable to multiple sector antenna units supporting N sectors, where N≧2, the sectors being associated with respective cell identities, ids, the RBS comprising N Radio Units, RUs, serving said sectors, the RBS further comprising a processing unit adapted to:
transmit by means of an RU, in each individual sector, the respective cell id associated with the sector,
decide that at least two separate sectors shall be merged, and to decide which at least two sectors out of the N sectors that shall be merged,
identify the respective cell id of the at least two sectors,
determine one cell id out of the identified cell ids that shall be active, wherein the remaining cell id(s) out of the identified cell ids shall be passive,
transition, in each sector associated with a cell id that shall be passive, from transmitting the cell id that shall be passive to transmitting the one determined cell id that shall be active, and adapted to
switch off RU(s) responsible for transmitting the cell ids which has become passive when a transmission power for transmitting those cell id(s) has reached a threshold power value.

11. An RBS according to claim 10, wherein the processing unit is adapted to add, at a predetermined transmission power, the determined one cell id in those sectors associated with cell ids that shall be passive and to successively increase the transmission power of the determined one cell id, and to successively reduce the transmission power with which the cell id(s) which shall be passive are transmitted in each respective sector.

12. An RBS according to claim 10, wherein the processing unit further is adapted to connect the RU originally responsible for transmitting the one determined active cell id in a respective sector with antenna units supporting all the merged sectors.

13. An RBS according to claim 10, wherein the processing unit is adapted to determine that at least two individual sectors shall be merged by receiving, from a controller of the radio network, an message with instruction(s) to merge the at least two individual sectors.

14. An RBS according to claim 10, wherein the processing unit is adapted to determine that at least two individual sectors shall be merged by determining, in the RBS, that a current load of the RBS is below a predefined load threshold.

15. An RBS according to claim 10, wherein the processing unit is adapted to determine that at least two individual sectors shall be merged by detecting that a predefined time of day has been reached.

16. An RBS according to claim 10, wherein the processing unit further is adapted to:
decide that the merged sectors shall be divided into at least two separate sectors,
identify at least one cell id available for the RBS which is passive and not in use,
switch on at least one RU not currently in use,
connect the switched-on RU(s) with antenna units supporting transmission in a part of the merged sectors that shall be divided, for transmitting the identified at least one cell id which is passive at the predetermined transmission power and transmitting the active cell id at relatively high transmission power, and to
transition, in the merged sectors to be divided from transmitting the active cell id in the merged sectors to transmitting the active cell id in one part of the merged sectors constituting a first new sector and transmitting the at least one passive cell id in a respective separate at least one part of the merged sectors constituting at least one second new sector.

17. An RBS according to claim 10, wherein the cell ids are scrambling codes and the RBS is employed in a Wideband Code Divisional Multiple Access, WCDMA, based radio communication system.

18. An RBS according to claim 10, wherein the RBS is employed in a CDMA based communication system, a Global System for Mobile Communication, GSM, or a Long Term Evolution, LTE, based system.
